(19) United States
(12) Patent Application Publication
(10) Pub. No.: US 2015/0345390 A1
(43) Pub. Date: Dec. 3, 2015

(54) SYSTEMS AND METHODS FOR DE-ICING INLET SCREENS AND DEHUMIDIFYING INLET AIR FILTERS FOR GAS TURBINE ENGINES

(71) Applicant: General Electric Company, Schenectady, NY (US)

(72) Inventors: Sanji Ekanayake, Atlanta, GA (US); Alston Ilford Scipio, Atlanta, GA (US); Joseph Klosinski, Atlanta, GA (US); Dale J. Davis, Greenville, SC (US)

(73) Assignee: General Electric Company, Schenectady, NY (US)

(21) Appl. No.: 14/290,600

(22) Filed: May 29, 2014

(51) Int. Cl. F02C 7/047

(52) U.S. Cl. CPC F02C 7/047

(57) ABSTRACT

Systems and methods for de-icing an inlet screen and dehumidifying an inlet air filter in a gas turbine engine are disclosed herein. In one embodiment, a method may include determining a current inlet screen temperature. The method also may include determining a desired inlet screen temperature. If the current inlet screen temperature is less than the desired inlet screen temperature, the method may further include determining a first amount of gas turbine compartment ventilation discharge air necessary to achieve the desired inlet screen temperature, extracting the first amount of gas turbine compartment ventilation discharge air, and conveying the first amount of gas turbine compartment ventilation discharge air to the inlet screen.

### FIELD OF THE DISCLOSURE

The disclosure relates generally to gas turbine engines and more particularly relates to systems and methods for de-icing inlet screens and dehumidifying inlet air filters for gas turbine engines.

### BACKGROUND

Gas turbine engines are utilized globally for electric power generation or as mechanical drives for operating equipment under a variety of climatic conditions. Operation during cold ambient temperature and high humidity conditions often causes ice to build up on the inlet filter house components. Frequently, this ice build-up on air filtration elements (e.g., bird screens, moisture separators, coalescer filters, or filtration modules) is severe enough to restrict air flow and to increase the inlet air pressure drop across the filter house, thus leading to performance loss or even shut down. Precipitating icing forms when water ingested as liquid or solid at a temperature near or below freezing (e.g., wet snow, freezing rain, etc.) adheres to most exposed surfaces, causing ice buildup. Also, ice formation occurs when saturated cooled air comes in contact with colder filter house surfaces.

### SUMMARY

Some or all of the above needs and/or problems may be addressed by certain embodiments of the disclosure. The disclosure provides systems and methods for de-icing an inlet screen and dehumidifying an inlet air filter in a gas turbine engine. In one embodiment, a method for de-icing an inlet screen and dehumidifying an inlet air filter in a gas turbine engine may include determining a current inlet screen temperature. The method also may include determining a desired inlet screen temperature. If the current inlet screen temperature is less than the desired inlet screen temperature, the method may further include determining a first amount of gas turbine compartment ventilation discharge air necessary to achieve the desired inlet screen temperature, extracting the first amount of gas turbine compartment ventilation discharge air, and conveying the first amount of gas turbine compartment ventilation discharge air to the inlet screen.

In another embodiment, the disclosure provides a system for de-icing an inlet screen and dehumidifying an inlet air filter in a gas turbine engine. The system may include a gas turbine engine, a gas turbine compartment disposed about the gas turbine engine, an inlet screen configured to provide air to the gas turbine engine, a manifold coupled to the inlet screen, and a first conduit fluidly coupling the gas turbine compartment and the manifold.

In yet another embodiment, the disclosure provides a system for de-icing an inlet screen and dehumidifying an inlet air filter in a gas turbine engine. The system may include a compressor, a combustor in communication with the compressor, and a turbine in communication with the combustor. The system also includes a gas turbine compartment disposed about the compressor, the combustor, and the turbine. Moreover, the system includes an inlet screen configured to provide air to the compressor, a manifold coupled to the inlet screen, and a first conduit fluidly coupling the gas turbine compartment and the manifold.

These and other embodiments, aspects, and features of the disclosure will become apparent to those skilled in the art from the following detailed description, the accompanying drawings, and the appended claims.

### BRIEF DESCRIPTION OF THE DRAWINGS

Reference will now be made to the accompanying drawings, which are not necessarily drawn to scale.

FIG. 1 is a schematic view of a system according to one or more embodiments.

FIG. 2 is a schematic view of a system according to one or more embodiments.

FIG. 3 is a schematic of an embodiment of a control system according to one or more embodiments.

FIG. 4 is a flow chart illustrating a method according to one or more embodiments.

### DETAILED DESCRIPTION

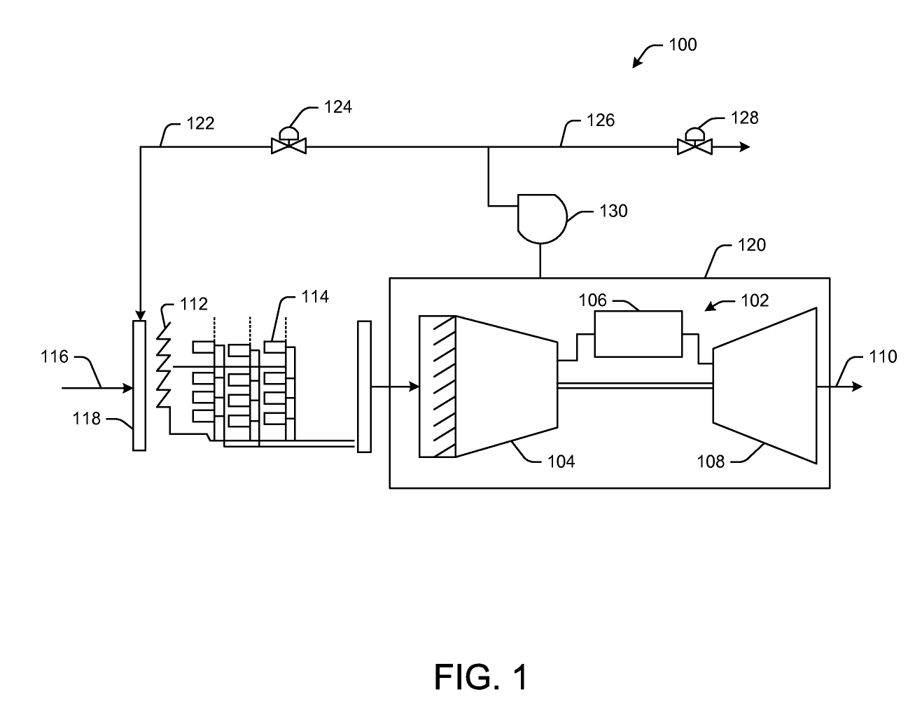

Referring now to the drawings, in which like numerals refer to like elements throughout the several views, FIG. 1 is an example embodiment of a system 100 for de-icing a gas turbine engine inlet screen and dehumidifying inlet air filters. The system 100 may include one or more gas turbine engines 102. Each gas turbine engine 102 may include a compressor 104, a combustor 106, and a turbine 108. The compressor 104 may compress an incoming flow of air. The compressor 104 may deliver the compressed flow of air to the combustor 106, where the compressed flow of air mixes with a compressed flow of fuel. The air/fuel mixture may be ignited to create a flow of combustion gases. The flow of combustion gases may be delivered to the turbine 108. The flow of combustion gases may drive the turbine 108 to produce mechanical work. The mechanical work produced in the turbine 108 may drive the compressor 104 and an external load, such as an electrical generator or the like. The flow of combustion gases may be exhausted via an exhaust subsystem 110 or the like to a stack or otherwise disposed.

The gas turbine engine 102 may use natural gas, various types of syngas, and/or other types of fuels. The gas turbine engine 102 may be anyone of a number of different gas turbine engines such as those offered by General Electric Company of Schenectady, N.Y. and the like. The gas turbine engine 102 may have different configurations and may use other types of components. Other types of gas turbine engines also may be used herein. Multiple gas turbine engines, other types of turbines, and other types of power generation equipment also may be used herein together.

The gas turbine engine 102 may include an inlet screen 112 or filter house that includes one or more filter assemblies having a number of inlet air filters 114 that remove moisture and/or particulate matter (such as dust and/or debris) from intake air 116 channeled to the gas turbine engine 102. In some instances, a manifold 118 may be coupled to the inlet screen 112. The manifold 118 may be configured to de-ice the inlet screen 112 and/or dehumidify the inlet air filters 114.

The gas turbine engine 102 may be wholly or partially enclosed by a gas turbine compartment 120. During operation of the gas turbine engine 102, waste heat may be released into the gas turbine compartment 120, which in turn may heat the air within the gas turbine compartment 120. The system 100 utilizes the waste heat from the gas turbine compartment 120 for de-icing the inlet screen 112 and/or dehumidifying inlet air filters 114. For example, a first conduit 122 may fluidly couple the gas turbine compartment 120 with the manifold 118. In this manner, the heated air from the gas turbine compartment 120 may be used to de-ice the inlet screen 112 and/or dehumidifying inlet air filters 114. For example, a first control valve 124 may be disposed about the first conduit 122. The first control valve 124 may be adjusted to provide a first amount of gas turbine compartment ventilation discharge air necessary to achieve a desired inlet screen temperature. The desired inlet screen temperature may be sufficient to de-ice the inlet screen 112. In addition, the desired inlet temperature may be sufficient to de-humidify the inlet air filter 114.

In some instances, a second conduit 126 may fluidly couple the gas turbine compartment 120 with the surrounding atmosphere. In this manner, excess gas turbine compartment ventilation discharge air may be vented to the atmosphere or elsewhere. For example, a second control valve 128 may be disposed about the second conduit 126. The second control valve 128 may be adjusted to discharge a portion of the gas turbine compartment ventilation discharge air to the atmosphere.

The gas turbine compartment ventilation discharge air may be extracted from the gas turbine compartment 120 by at least one extraction blower 130 (or exhaust fan) disposed about the first conduit 122 and/or the second conduit 126. That is, the extraction blower 130 may draw the heated air out of the gas turbine compartment 120. In some instances, the heated air from the gas turbine compartment 120 may be supplied to the manifold 118 to de-ice the inlet screen 112 and/or dehumidifying the inlet air filters 114. In other instances, the heated air from the gas turbine compartment 120 may be discharged to the atmosphere.

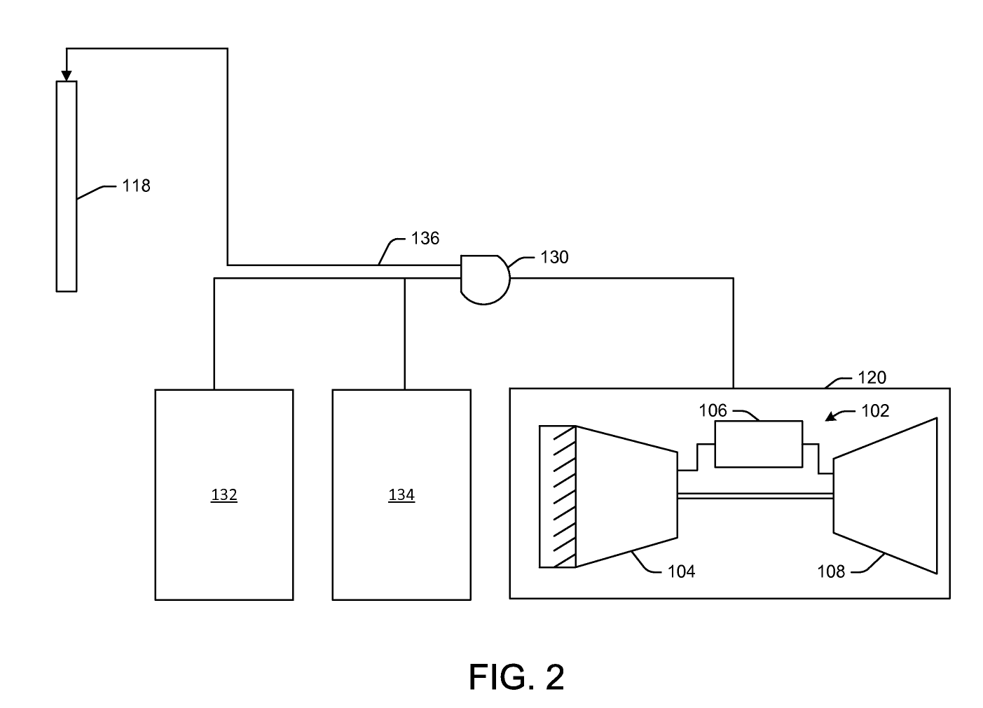

In some instances, additional sources of waste heat may be used in conjunction with or alternative to the waste heat from the gas turbine compartment 120 to de-ice the inlet screen 112 and/or dehumidifying inlet air filters 114. For example, as depicted in FIG. 2, waste heat (such as heated air) from an air cooled generator 132 and/or switchgear compartments 134 may be used. In some instances, one or more conduits 136 may fluidly couple the manifold 118 with the gas turbine compartment 120, the air cooled generator 132, and/or switchgear compartment 134. In addition, the extraction blower 130 may draw the heated air out of the gas turbine compartment 120, the air cooled generator 132, and/or switchgear compartment 134. Moreover, one or move control valves (not shown) may be disposed about the one or more conduits 136 to control the flow or combination of flows therein.

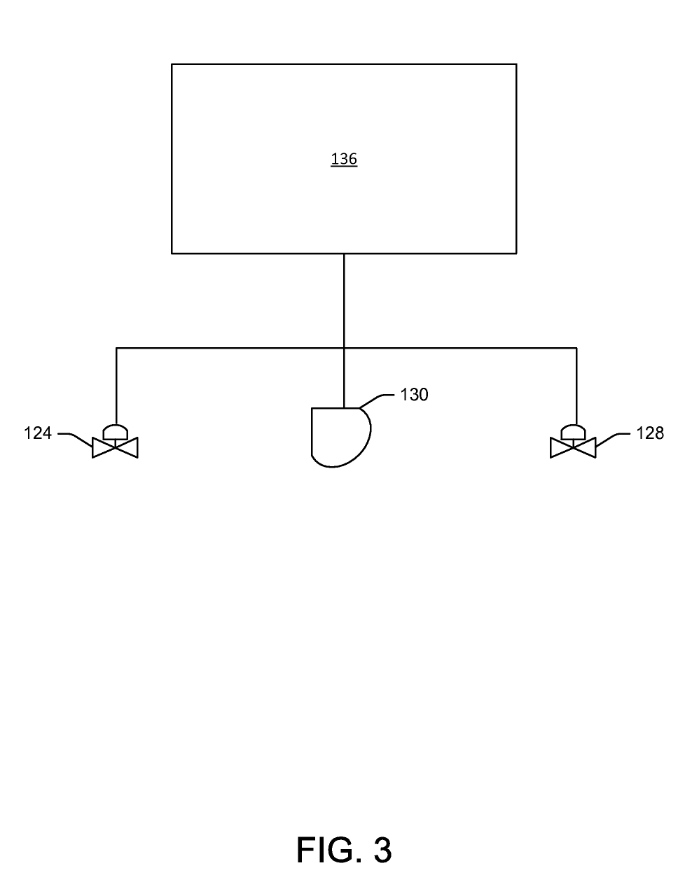

As depicted in FIG. 3, the position of the first control valve 124 and/or the second control valve 128 may be controlled by a controller 136. The controller 136 also may control the extraction blower 130. Moreover, the controller 136 may receive inputs from one or more sensors disposed about the first conduit 122, the second conduit 126, the inlet screen 112, the inlet air filters 114, among others. The controller 136 may be configured to activate one or more actuators. The controller 136 may be an independent controller or integrated with a gas turbine control system. The controller 136 may include at least a memory and one or more processing units (or processor(s)). The processor(s) may be implemented as appropriate in hardware, software, firmware, or combinations thereof. Software or firmware implementations of the processor(s) may include computer-executable or machine-executable instructions written in any suitable programming language to perform the various functions described herein. Moreover, the processor may be associated with a network, a server, a computer, or a mobile device.

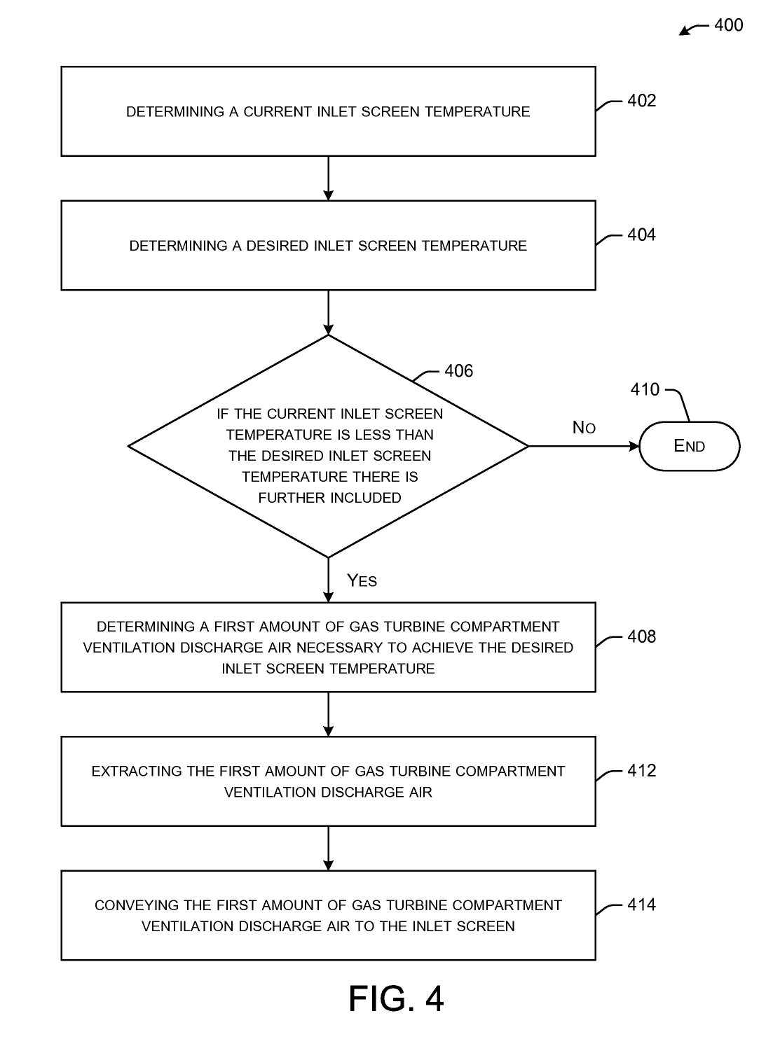

FIG. 4 is a flow chart illustrating a method 400 for de-icing the inlet screen and/or dehumidifying the inlet air filter according to one or more embodiments of the disclosure. At block 402, a current inlet screen temperature may be determined. For example, one or more sensors may be disposed about the inlet screen 112 and/or the inlet air filters 114. The sensors may be in communication with the controller 136. At block 404, a desired inlet screen temperature may be determined. For example, the desired inlet screen temperature may be sufficient to de-ice the inlet screen 112 and/or to de-humidify the inlet air filter 114. At block 406, if the current inlet screen temperature is less than the desired inlet screen temperature, then the method 400 proceeds to block 408. If not, then the method ends at block 410.

At block 408, a first amount of gas turbine compartment ventilation discharge air necessary to achieve the desired inlet screen temperature may be determined. Next, at block 412, the first amount of gas turbine compartment ventilation discharge air may be extracted from the gas turbine compartment. For example, the extraction blower 130 may draw the heated air out of the gas turbine compartment 120. The first amount of gas turbine compartment ventilation discharge air may then be conveyed to the inlet screen at block 414. For example, the first control valve 124 may be adjusted to provide the first amount of gas turbine compartment ventilation discharge air necessary to achieve the desired inlet screen temperature.

It should be apparent that the foregoing relates only to certain embodiments of the present application and that numerous changes and modifications may be made herein by one of ordinary skill in the art without departing from the general spirit and scope of the disclosure as defined by the following claims and the equivalents thereof.

That which is claimed is:

1. A method for de-icing an inlet screen and dehumidifying an inlet air filter in a gas turbine engine, the method comprising:
determining a current inlet screen temperature;
determining a desired inlet screen temperature;
if the current inlet screen temperature is less than the desired inlet screen temperature there is further included:
determining a first amount of gas turbine compartment ventilation discharge air necessary to achieve the desired inlet screen temperature;
extracting the first amount of gas turbine compartment ventilation discharge air; and
conveying the first amount of gas turbine compartment ventilation discharge air to the inlet screen.

2. The method of claim 1, wherein conveying the first amount of gas turbine compartment ventilation discharge air to the inlet screen comprises adjusting a first control valve.

3. The method of claim 1, wherein extracting the first amount of gas turbine compartment ventilation discharge air comprises controlling at least one extraction blower.

4. The method of claim 1, further comprising discharging a second amount of gas turbine compartment ventilation discharge to the atmosphere.

5. The method of claim 4, wherein discharging a second amount of gas turbine compartment ventilation discharge to the atmosphere comprises adjusting a second control valve.

6. The method of claim 1, wherein the desired inlet screen temperature is sufficient to de-ice the inlet screen.

7. The method of claim 1, wherein the desired inlet temperature is sufficient to de-humidify the inlet air filter.

8. A system for de-icing an inlet screen and dehumidifying an inlet air filter in a gas turbine engine, comprising:
a gas turbine engine;
a gas turbine compartment disposed about the gas turbine engine;
an inlet screen configured to provide air to the gas turbine engine;
a manifold coupled to the inlet screen; and
a first conduit fluidly coupling the gas turbine compartment and the manifold.

9. The system of claim 8, further comprising a first control valve disposed about the first conduit, wherein the first control valve is configured to provide a first amount of gas turbine compartment ventilation discharge air necessary to achieve a desired inlet screen temperature.

10. The method of claim 9, wherein the desired inlet screen temperature is sufficient to de-ice the inlet screen.

11. The method of claim 9, wherein the desired inlet temperature is sufficient to de-humidify an inlet air filter.

12. The system of claim 8, further comprising a second conduit fluidly coupling the gas turbine compartment and the atmosphere.

13. The system of claim 12, further comprising a second control valve disposed about the second conduit.

14. The system of claim 8, further at least one extraction blower disposed about the first conduit.

15. The system of claim 8, wherein the gas turbine engine comprises:
a compressor;
a combustor in communication with the compressor; and
a turbine in communication with the combustor.

16. The system of claim 8, further comprising one or more inlet air filters associated with the inlet screen.

17. The system of claim 8, further comprising additional waste heat sources in communication with the manifold.

18. A system for de-icing an inlet screen and dehumidifying an inlet air filter in a gas turbine engine, comprising:
a compressor;
a combustor in communication with the compressor;
a turbine in communication with the combustor;
a gas turbine compartment disposed about the compressor, the combustor, and the turbine;
an inlet screen configured to provide air to the compressor;
a manifold coupled to the inlet screen;
a first conduit fluidly coupling the gas turbine compartment and the manifold; and
a first control valve disposed about the first conduit, wherein the first control valve is configured to provide a first amount of gas turbine compartment ventilation discharge air necessary to achieve a desired inlet screen temperature.

19. The method of claim 18, wherein the desired inlet screen temperature is sufficient to de-ice the inlet screen.

20. The method of claim 18, wherein the desired inlet temperature is sufficient to de-humidify an inlet air filter.
